(19) United States
(12) Patent Application Publication
(10) Pub. No.: US 2023/0323507 A1
(43) Pub. Date: Oct. 12, 2023

(54) METHOD OF RECYCLING NICKEL FROM WASTE BATTERY MATERIAL

(71) Applicant: JOHNSON MATTHEY PUBLIC LIMITED COMPANY, London (GB)

(72) Inventors: Barbara BREEZE, Reading, Berkshire (GB); Michael BROWNE, Reading, Berkshire (GB); Benjamin EADE, Reading, Berkshire (GB); Emma SCHOFIELD, Reading, Berkshire (GB); Koen VANDAELE, Reading, Berkshire (GB)

(21) Appl. No.: 18/040,744

(22) PCT Filed: Aug. 11, 2021
(86) PCT No.: PCT/GB2021/052084

§ 371 Date: Feb. 6, 2023

(30) Foreign Application Priority Data
Aug. 20, 2020 (GB) 2012995.3

(51) Int. Cl. C22B 23/02; H01M 10/054; C22B 7/00; C22B 3/00; C01G 53/10

(52) U.S. Cl. CPC C22B 23/021; H01M 10/054; C22B 7/002; C22B 7/007; C22B 23/0415; C01G 53/10

(57) ABSTRACT

A method is described for recycling nickel from waste battery material. The method includes providing waste battery material comprising a nickel-containing oxide, reducing the nickel in the waste battery material to the zero oxidation state to provide a reduced waste battery material, reacting the reduced waste battery material with carbon monoxide to form Ni(CO)₄, and reacting the Ni(CO)₄ with a source of sulfate to form NiSO₄. The NiSO₄ product is useful as a nickel feedstock in various processes which require a nickel source, including processes which prepare new battery materials.

### FIELD OF THE INVENTION

The present invention relates to methods of recycling nickel from waste battery material, and in particular to methods of recycling nickel from waste battery cathode material.

### BACKGROUND OF THE INVENTION

Lithium ion batteries are now ubiquitous in modern society, finding use not only in small, portable devices such as mobile phones and laptop computers but also increasingly in electric vehicles.

A lithium ion battery generally includes an anode (e.g. graphite) separated from a cathode by an electrolyte, through which lithium ions flow during charging and discharging cycles. The cathode in a lithium ion battery may include a lithium transition metal oxide, for example a lithium nickel oxide, lithium cobalt oxide or lithium manganese oxide, or a lithium mixed transition metal oxide comprising a mixture of two or more transition metals.

Although lithium ion and other modern rechargeable batteries offer promising low-carbon energy storage for the future, one concern is that the metals required for their manufacture, such as lithium, nickel, cobalt or manganese, often command high prices due to their limited availability at the required purity and difficulty of extraction from natural sources. The finite nature of supplies of metals such as nickel and cobalt makes it desirable to limit the loss of these elements through the disposal of battery materials in landfill, for both sustainability and environmental reasons. Despite this, the complexity of existing methods for recycling such elements from battery materials means that they are often lost in this way. There is therefore a need for methods which reclaim and recycle the metals present within batteries, such as the metals present within the cathodes of batteries, to provide recycled material which may be used as feedstock in battery manufacture.

CN 103031441 describes a method of recycling metallic elements from waste nickel-hydride batteries. Waste nickel-hydride battery powder is reduced and calcined, then reacted with a zinc salt solution. The solution is filtered and the filter residue is added to an acid solution with an oxidant, followed by potassium permanganate. The solution is filtered, with manganese dioxide being recoverable from the filter residue and nickel and cobalt being recoverable from the filtrate. Such a method has many steps including various reaction and filtration steps, and the recovered metals would require further processing steps before being in a form useful for the manufacture of further battery materials.

There is therefore a need for improved processes for reclaiming and recycling metallic elements such as nickel from waste battery materials, such as cathode materials, which are economical and provide metallic elements in a more useful form for further processing.

Given the recent move in the lithium ion battery sector towards electrode materials with high nickel loading, the reclaiming and recycling of nickel from these materials in a useful form is of particular interest. Although nickel is a relatively common element, obtaining nickel at the level of purity required for use in the manufacture of battery materials is difficult. There is therefore a need for methods which not only reclaim nickel from these materials but do so in a form which is of a form and purity suitable for battery manufacture applications.

### SUMMARY OF THE INVENTION

A first aspect described in the present specification is a method of recycling nickel from waste battery material comprising:
(a) providing waste battery material comprising a nickel-containing compound;
(b) reducing at least some of the nickel in the waste battery material to the zero oxidation state to provide a reduced waste battery material;
(c) reacting the reduced waste battery material with carbon monoxide to form Ni(CO)₄; and
(d) reacting the Ni(CO)₄ with a source of sulfate to form NiSO₄.

This method generates nickel sulfate (NiSO₄) from the waste battery material. The nickel sulfate may then be used as a nickel feedstock in various processes which require a nickel source, including processes which prepare new battery materials, or used as an intermediate to prepare other compounds useful as a nickel feedstock.

The invention therefore provides a useful process whereby nickel may be recycled from waste battery materials via the Ni(CO)₄ intermediate. The process is economical in requiring only a small number of steps with few reagents, such that the yield of recycled nickel is high. The carbon monoxide used as a reagent in step (c) may be obtained from the decomposition of the Ni(CO)₄ intermediate in step (d), providing a cyclic process with very little waste. It is also possible to perform the process in a single reaction vessel in which both the reduction and carbonylation steps may be performed, eliminating the need to move or handle the materials, thereby simplifying the process and making scale-up more feasible and straightforward.

The Ni(CO)₄ intermediate which results from the process contains nickel which is essentially free from impurities and may be converted to a nickel feedstock of very high purity for use in battery material manufacture. Since the process of the invention removes nickel from the waste battery material, this makes the subsequent recycling of residual metals such as cobalt or manganese from the material more straightforward due to the reduced nickel content.

A second aspect described in the present specification is a method of recycling nickel from a waste battery material, wherein the method comprises:
reacting a composition comprising reduced waste battery material with carbon monoxide to form Ni(CO)₄, wherein the reduced battery material comprises nickel in the zero oxidation state; and
reacting the Ni(CO)₄ with a source of sulfate to form NiSO₄.

A third aspect described in the present specification is a method of recycling nickel from a waste battery material, wherein the method comprises:
reacting a composition comprising reduced carbonylated waste battery material with a source of sulfate to form NiSO₄, wherein the reduced carbonylated waste battery material comprises Ni(CO)₄.

A fourth aspect described in the present specification is the use of carbon monoxide as a carbonylation reagent to convert a composition comprising reduced waste battery material to Ni(CO)₄.

A fifth aspect described in the present specification is the use of sulfuric acid as a reagent to convert a composition comprising reduced carbonylated waste battery material to NiSO₄, wherein the reduced carbonylated waste battery material comprises Ni(CO)₄.

A sixth aspect described in the present specification is a method of recycling nickel from waste battery material comprising:
(a) providing waste battery material comprising a nickel-containing compound;
(b) treating the waste battery material with formic acid forming nickel formate;
(b) reducing at least some of the nickel formate in the waste battery material to the zero oxidation state to provide a reduced waste battery material;
(c) reacting the reduced waste battery material with carbon monoxide to form Ni(CO)₄; and

(d) optionally reacting the Ni(CO)₄ with a source of sulfate to form NiSO₄.

### DESCRIPTION OF THE FIGURES

FIG. 1 shows one embodiment of a setup for reacting the Ni(CO)₄ gas with sulfuric acid using a network of gas scrubbers.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

A method of recycling nickel from waste battery material is provided comprising:
(a) providing waste battery material comprising a nickel-containing compound;
(b) reducing at least some of the nickel in the waste battery material to the zero oxidation state to provide a reduced waste battery material; and
(c) reacting the reduced waste battery material with carbon monoxide to form Ni(CO)₄.

In some embodiments, the method is a gas-phase process of recycling nickel from waste battery material. Herein, the term “gas phase process” refers to a process in which at least one reactant, intermediate or product is gaseous under the conditions of the reaction.

The first step of the method comprises providing waste battery material comprising a nickel-containing compound.

Herein, the term “waste battery material” denotes any material component of an electrical energy storage device such as a cell or battery, or a derivative thereof, from which it is desired to recycle one or more of the constituent elements for further use. The waste battery material may have been previously used within an electrical energy storage device, although this is not essential. The waste battery material may be waste material generated during the production of battery materials, including for example waste intermediate materials or failed batches. The further use may be in any application, but in some embodiments the further use is in the production of further materials for use in an electrical energy storage device.

The term “derivative” as used herein in relation to the material component of an electrical energy storage device such as a cell or battery denotes a material which is obtained from subjecting the material component to one or more treatment steps to alter its chemical composition. In some embodiments, the waste battery material comprises waste battery cathode material or a derivative thereof.

The cathodes of batteries, such as lithium-ion batteries, often include mixed oxides as an active material which provides lithium intercalation. The mixed oxides may be mixed transition metal oxides. The waste battery material used in the method comprises a nickel-containing compound. In some embodiments, the nickel-containing compound is a nickel-containing oxide. In some embodiments, the nickel-containing oxide is a mixed oxide containing nickel and one or more additional metals.

The nickel-containing compound may be a nickel-containing oxide, for example a mixed oxide comprising nickel and lithium, i.e. a lithium nickel oxide (LNO). The nickel-containing compound may be a mixed oxide comprising nickel, lithium and cobalt, i.e. lithium nickel cobalt oxide (LNCO). The nickel-containing compound may be a mixed oxide comprising nickel, lithium and manganese, i.e. lithium manganese nickel oxide (LMNO). The nickel-containing compound may be a mixed oxide comprising nickel, lithium, manganese and cobalt, i.e. lithium manganese nickel cobalt oxide (LMNCO). The nickel-containing compound is not particularly limited and nickel may be recycled from any battery material which comprises a nickel-containing compound.

In some embodiments, the nickel-containing compound is a mixed oxide further comprising one or more of lithium, cobalt and manganese and optionally further comprising one or more of iron, aluminium, copper and carbon. In some embodiments, the nickel-containing compound is a mixed oxide further comprising two or more of lithium, cobalt and manganese. In some embodiments, the nickel-containing compound is a mixed oxide further comprising lithium, cobalt and manganese.

The waste battery material may also comprise carbon, which may often be used as a binder in battery materials, such as cathode materials. Such carbon may also be useful during the reduction step described below, to provide a carbonaceous atmosphere for carbothermic reduction.

An advantage of the method of the invention is that nickel carbonyl is easily separated from other products which may be formed during the reaction of the reduced waste battery material with carbon monoxide. Nickel carbonyl is volatile, existing as a gas at atmospheric pressure and temperatures above 43° C. and will be generated by the method as a gas-phase intermediate which can be easily extracted. Iron carbonyl (Fe(CO)₅) may be formed through the reaction of any iron in the nickel-containing oxide with CO, but is less volatile than Ni(CO)₄, having a boiling point of 104° C. Cobalt carbonyl, Co₂(CO)₈ is a solid below 51° C.

The method of the invention therefore offers a means to selectively reclaim and recycle nickel via Ni(CO)₄ from waste battery materials where the waste battery materials comprise a mixture of metals such as nickel, cobalt and/or iron.

In some embodiments, the waste battery material comprises black mass obtained from the mechanical disassembly of a battery. Such “black mass” is a material well-known to the skilled person. The black mass may comprise cathode black mass, or may comprise a mixture of cathode and anode black mass. The mechanical disassembly may include shredding the battery pack and separating one or more of the components.

The waste battery material may comprise at least 10 wt % Ni based on the total mass of waste battery material, for example at least 12 wt %, at least 15 wt %, at least 20 wt % or at least 25 wt %. The waste battery material may comprise up to 80 wt % Ni based on the total mass of waste battery material, for example up to 75 wt %, up to 70 wt % or up to 50 wt %. The waste battery material may comprise from 10 to 80 wt % Ni based on the total mass of waste battery material.

The waste battery material may comprise at least 0 wt % Mn based on the total mass of waste battery material, for example at least 1 wt %, at least 2 wt %, at least 5 wt % or at least 10 wt %. The waste battery material may comprise up to 33 wt % Mn based on the total mass of waste battery material, for example up to 30 wt %, up to 28 wt % or up to 25 wt %. The waste battery material may comprise from 0 to 33 wt % Mn based on the total mass of waste battery material.

The waste battery material may comprise at least 0 wt % Co based on the total mass of waste battery material, for example at least 1 wt %, at least 2 wt %, at least 5 wt % or at least 10 wt %. The waste battery material may comprise up to 33 wt % Co based on the total mass of waste battery material, for example up to 30 wt %, up to 28 wt % or up to 25 wt %. The waste battery material may comprise from 0 to 33 wt % Co based on the total mass of waste battery material.

The waste battery material may comprise at least 0 wt % Li based on the total mass of waste battery material, for example at least 1 wt %, at least 2 wt %, at least 5 wt % or at least 6 wt %. The waste battery material may comprise up to 20 wt % Li based on the total mass of waste battery material, for example up to 18 wt %, up to 15 wt % or up to 12 wt %. The waste battery material may comprise from 0 to 20 wt % Li based on the total mass of waste battery material.

The waste battery material may comprise at least 0 wt % Fe based on the total mass of waste battery material, for example at least 1 wt %, at least 2 wt % or at least 3 wt %. The waste battery material may comprise up to 10 wt % Fe based on the total mass of waste battery material, for example up to 9 wt %, up to 8 wt % or up to 7 wt %. The waste battery material may comprise from 0 to 10 wt % Fe based on the total mass of waste battery material.

The waste battery material may comprise at least 0 wt % Al based on the total mass of waste battery material, for example at least 1 wt %, at least 2 wt % or at least 3 wt %. The waste battery material may comprise up to 10 wt % Al based on the total mass of waste battery material, for example up to 9 wt %, up to 8 wt % or up to 7 wt %. The waste battery material may comprise from 0 to 10 wt % Al based on the total mass of waste battery material.

The waste battery material may comprise at least 0 wt % Cu based on the total mass of waste battery material, for example at least 1 wt %, at least 2 wt % or at least 3 wt %. The waste battery material may comprise up to 20 wt % Cu based on the total mass of waste battery material, for example up to 15 wt %, up to 10 wt %, up to 9 wt %, up to 8 wt % or up to 7 wt %. The waste battery material may comprise from 0 to 20 wt % Cu based on the total mass of waste battery material.

The waste battery material may comprise at least 0 wt % C based on the total mass of waste battery material, for example at least 1 wt %, at least 5 wt %, at least 10 wt % or at least 15 wt %. The waste battery material may comprise up to 50 wt % C based on the total mass of waste battery material, for example up to 45 wt %, up to 40 wt % or up to 30 wt %. The waste battery material may comprise from 0 to 50 wt % C based on the total mass of waste battery material.

The waste battery material may comprise from 10 to 80 wt % Ni, from 0 to 33 wt % Mn, from 0 to 33 wt % Co, from 0 to 20 wt % Li, from 0 to 10 wt % Fe, from 0 to 10 wt % Al, from 0 to 20 wt % Cu and from 0 to 50 wt % C based on the total mass of waste battery material.

The waste battery material may originate from any suitable battery, including but not limited to lithium-ion batteries, lithium-metal batteries, solid state lithium-metal batteries and metal-air batteries. Any suitable nickel-containing component of a battery may be recycled using the present method, including but not limited to cathode materials, anode materials and electrolytes.

The active material within the waste battery material may have a composition according to formula I:

LiₓNi_{y}Co_{z}MnₚAl_{q}MᵣOₐ Formula I
wherein
M is one or more of Al, V, Ti, B, Zr, Sr, Ca, Mg, Cu, Sn, Cr, Fe, Ga, Si, W, Mo, Ta, Y, Sc, Nb, Pb, Ru, Rh and Zn;
0.5≤x≤1.5
0<y≤1.0
0≤z≤1.0
0≤p≤1.0
0≤q≤1.0
0≤r≤0.1 and
1.8≤a≤2.2.

In some embodiments, r=0, such that the active material within the waste battery material has the composition LiₓNi_{y}Co_{z}MnₚAl_{q}Oₐ.

The second step of the method comprises reducing at least some of the nickel in the waste battery material to the zero oxidation state to provide a reduced waste battery material. The nickel in the waste battery material may be in the form of a nickel oxide where nickel (and any other metal present) exists in an oxidation state greater than zero, hence reduction of the nickel reduces the oxidation state to zero, providing elemental nickel to enable the subsequent reaction with carbon monoxide.

The step of reducing at least some of the nickel in the waste battery material may comprise direct reduction of the nickel-containing compound in the material, i.e. the conversion to zero oxidation state nickel in a single step by reducing the nickel-containing compound. Alternatively, the reduction may be performed in a multi-step process. For example, the nickel-containing compound in the waste battery material may be a nickel-containing oxide which is first converted into a nickel-containing derivative of the nickel-oxide. In some embodiments, the step of reducing at least some of the nickel in the waste battery material comprises converting the nickel-containing oxide into a nickel-containing derivative other than an oxide.

Thus in some embodiments, the method comprises:
(a) providing a waste battery material comprising a nickel-containing oxide;
(b) reducing at least some of the nickel in the waste battery material to the zero oxidation state to provide a reduced waste battery material, wherein the reduction comprises:
   (i) converting the nickel-containing oxide into a nickel-containing derivative other than an oxide, and
   (ii) reducing at least some of the nickel in the nickel-containing derivative to provide the reduced waste battery material;
   and
(c) reacting the reduced waste battery material with carbon monoxide to form Ni(CO)₄.

Herein, the term “reduced waste battery material” denotes a battery material which has been subjected to a reduction process (for example, reacted with a reductant) such that one or more metals present within the waste battery material have undergone a change in oxidation state from an initial higher oxidation state to a subsequent lower oxidation state.

In some embodiments, the step of reducing the nickel in the process of the invention comprises contacting the waste battery material with a reducing atmosphere. In some embodiments, reducing the nickel comprises placing the waste battery material under a reducing atmosphere at elevated temperature. In some embodiments the reducing atmosphere comprises a reducing gas. The reducing gas may comprise H₂. This may be a suitable option when the nickel-containing compound is a nickel-containing oxide which is directly reduced to nickel metal. In other embodiments, the reduction may be a carbothermic reduction, with a reducing gas generated either from carbon present in the waste battery material or from carbon added to the waste battery material before the reduction.

It is common for battery materials such as lithium-ion battery cathode materials to contain some carbon, for example as a binder. In such cases, the waste battery material derived from these materials will also contain some carbon. The reduction of the nickel in these waste battery materials may therefore be achieved through a carbothermic reduction in which the carbon already present acts as the reducing agent, and in such circumstances it may not be necessary to use any additional reducing agent such as H₂. In some embodiments, where a carbothermic reduction is performed, this is done under an inert atmosphere, for example a N₂ atmosphere. However it may still be preferred to include some H₂ in the atmosphere during carbothermic reduction, which helps to prevent any re-oxidation of the reduced nickel metal by any oxygen present in the gas feed.

In embodiments where the waste battery material does not contain carbon, it would be possible to introduce carbon into the waste battery material so that a carbothermic reduction may be performed. However in such embodiments it is instead preferred to use a reducing atmosphere comprising a reducing agent, for example H₂ or CO, without the addition of carbon to the waste battery material, because a further feed preparation step to add carbon to the material would be detrimental to the efficiency of the process.

Before contacting with the reducing atmosphere, the method may comprise heating the waste battery material up to a suitable temperature for reduction. By heating the waste battery material before feeding in the reducing atmosphere, the process becomes more efficient because gas from the reducing atmosphere is not wasted. The waste battery material may be heated up to a temperature of at least 350° C., for example at least 400° C., for example at least 450° C., for example at least 500° C., for example at least 520° C., at least 540° C., at least 560° C., at least 580° C. or at least 600° C. The waste battery material may be heated up to a temperature of up to 1000° C., for example up to 950° C., up to 900° C., up to 850° C. or up to 800° C. The waste battery material may be heated up to a temperature of from 600° C. to 900° C. Such temperatures may be a suitable option when the nickel-containing compound is a nickel-containing oxide which is directly reduced to nickel metal. Heating and subsequent reduction of the waste battery material may be carried out in a suitable sealed reaction vessel with gas inlet and outlet.

The method may comprise feeding the reducing gas into the vessel containing the waste battery material, for example through a gas inlet, to create the reducing atmosphere. Feeding of the gas may be started before, during or after heating the vessel up to the desired temperature for the reduction.

The contacting with the reducing atmosphere may be carried out at a temperature of at least 350° C., for example at least 400° C., for example at least 450° C., for example at least 500° C., for example at least 520° C., at least 540° C., at least 560° C., at least 580° C. or at least 600° C. The contacting with the reducing gas may be carried out at a temperature of up to 1000° C., for example up to 950° C., up to 900° C., up to 850° C. or up to 800° C. The contacting with the reducing atmosphere may be carried out at a temperature of from 600° C. to 900° C. Such temperatures may be a suitable option when the nickel-containing compound is a nickel-containing oxide which is directly reduced to nickel metal.

The method may comprise flowing a stream of reducing gas over the waste battery material.

The reducing gas may comprise H₂. The reducing gas may consist of H₂. In some embodiments the reducing gas comprises H₂ and further comprises carbon monoxide. The reducing gas may be a mixture comprising H₂ and CO. In this way, the same gas feed may be used for both the reduction and the later carbonylation, improving efficiency and simplifying the process. In some embodiments, reducing at least some of the nickel comprises contacting the waste battery material with a reducing gas comprising H₂, wherein the contacting with the reducing gas is carried out at a temperature of at least 350° C., for example at least 500° C.

Without wishing to be bound by theory, it is believed that some metallic components of the waste battery material including Ni, Co, and Fe will be reduced by exposure to the reducing gas such that at least some of the atoms will be converted to their elemental (zero oxidation state) form. It is expected that Mn will not be reduced to the zero oxidation state, but from MnO₂ to MnO. It is also expected that any Al₂O₃ will not be reduced.

The reaction of the waste battery material with the reducing gas may be performed for at least 30 minutes, for example at least 45 minutes, at least 60 minutes, at least 90 minutes, at least 120 minutes or at least 150 minutes. The reaction of the waste battery material with the reducing gas may be performed for up to 10 hours, for example up to 8 hours, up to 5 hours or up to 4 hours. The reaction of the waste battery material with the reducing gas may be performed for a period of from 30 minutes to 10 hours, for example from 45 minutes to 8 hours, from 1 hour to 5 hours or from 2 hours to 5 hours.

In some embodiments, the nickel-containing compound is reduced at atmospheric pressure. The reducing gas may be supplied such that 450 to 4500 L of H₂ per kg of Ni is supplied at atmospheric pressure, for example from 450 to 4000 L of H₂ per kg of Ni, from 450 to 3500 L of H₂ per kg of Ni, from 450 to 3000 L of H₂ per kg of Ni, from 450 to 2000 L of H₂ per kg of Ni, from 450 to 1500 L of H₂ per kg of Ni, or about 900 L of H₂ per kg of Ni.

The method may further comprise cooling the reduced waste battery material from the temperature at which reduction takes place to a temperature in a range from 45 to 85° C., after reduction and before reacting the reduced waste battery material with carbon monoxide. The cooling step may comprise first placing the reduced battery material under an atmosphere of nitrogen before cooling. This helps to prevent the formation of iron carbonyl during the cooling procedure. In some embodiments, after the temperature has reached the lower temperature in a range from 45 to 85° C., the nitrogen gas flow is terminated and a suitable carbonylation gas is fed into the vessel. The cooling may comprise allowing the material to cool naturally, i.e. without any active cooling, or by cooling under the flow of nitrogen gas.

The process may be a batch process or a continuous process. The type of reactor used in the process is not limited, but suitable reactors include tube furnaces, rotary furnaces and fluidised bed reactors. Any suitable reactor for handling fine material, maximising solid-gas interaction and enabling heat transfer may be used.

At least some of the nickel in the waste battery material is reduced in this step. In some embodiments, at least 5 wt %, for example at least 10 wt %, at least 15 wt %, at least 20 wt %, at least 25 wt %, at least 30 wt % or at least 50 wt % of the nickel in the waste battery material is reduced to the zero oxidation state. In some embodiments, up to 100 wt % of the nickel in the waste battery material is reduced to the zero oxidation state.

In some embodiments the reduction step may be performed in accordance with the corresponding reduction step in the process described in CN103031441, the entire disclosure of which is incorporated herein by reference.

Optionally, the waste battery material is subjected to a formic acid leaching process prior to the reduction step. Such a formic acid leaching step can be used to selectively leach Li from the waste battery material. An example of such a process is described in GB patent application number 2016329.1 filed on 15 Oct. 2020, the entire disclosure of which is incorporated herein by reference. It has been found that there are additional benefits, described below, of using formic acid as feed preparation step for subsequent processing as described in the present specification.

During a formic acid leach (e.g. with boiling anhydrous formic acid or formic acid mixed with water), Li is selectively dissolved in formic acid. During this leaching process, a mixed oxide of Ni, Co and Mn react with formic acid and form insoluble formate salts. After filtering off the residue, the Ni formate and Co formate present in the residue can be reduced to metallic Ni and Co at significantly lower temperatures compared to the reduction of the oxides of Ni and Co themselves. The lower temperature reduction process then yields finer particles of Ni and Co. Benefits of using a formic acid treatment step prior to the reduction step in the present process include:
Lower reduction temperature, i.e. 250-350° C. compared to 500-1000° C., enabling a significant reduction in energy cost for the reduction process.
As a result of the low reduction temperature, trials have shown that finer particles of Ni are formed as there is less sintering (less particle growth) at low reduction temperatures.
The small Ni particles accelerate the formation of Ni(CO)₄ as the kinetics of the nickel carbonyl formation are correlated with the surface area of Ni.
Since nickel and cobalt formate decompose at significantly different temperatures, i.e. approx. 250° C. for Ni formate vs approx. 310° C. for Co formate, then the Ni can be magnetically separated from Co formate by performing the thermal decomposition of the mixed formate feed at a temperature between 250° C. and 310° C., for example, 270° C.

In light of the above, certain methods of the present specification comprise:
(a) providing waste battery material comprising a nickel-containing compound;
(b) treating the waste battery material with formic acid forming nickel formate; (b) reducing at least some of the nickel formate in the waste battery material to the zero oxidation state to provide a reduced waste battery material;
(c) reacting the reduced waste battery material with carbon monoxide to form Ni(CO)₄; and
(d) optionally reacting the Ni(CO)₄ with a source of sulfate to form NiSO₄.

Additionally or alternatively to performing a formic acid leaching process prior to the reduction step, it can also be desirable to perform a formic acid leach step after a reduction step (e.g. after a H₂ reduction) to convert any residual nickel oxide not in the zero oxidation state to nickel formate. This can improve the yield of the Ni(CO)₄ process. As such, a formic acid leaching process may be provided before or after the reduction step.

In some embodiments, the reduced material is directly subjected to carbonylation, without any intervening steps. However the process may include one or more additional process steps between the reduction and the carbonylation. For example, the reduced material may be reacted with H₂S before carbonylation. Without wishing to be bound by theory, it is believed that such reaction with H₂S may activate the material for carbonylation. In the description of carbonylation which follows, reference to the “reduced waste battery material” encompasses the direct product of the reduction or the product of one or more such intervening process steps.

After reduction of the waste battery material, the reduced waste battery material is reacted with carbon monoxide to form Ni(CO)₄ in a carbonylation reaction.

Without wishing to be bound by theory, it is believed that the carbonylation of Ni proceeds according to the following equation:

Ni+4CO→Ni(CO)₄.

In some embodiments, the carbonylation is carried out by contacting the reduced waste battery material with a carbonylation gas comprising CO. In some embodiments, the carbonylation gas may comprise a mixture of H₂ and CO. In some embodiments, the carbonylation gas is synthesis gas (“syngas”), or comprises syngas. Syngas is a fuel gas mixture which is produced from many sources, including natural gas, coal or biomass. The exact composition of syngas varies depending on the source and the method of generation, but it typically contains hydrogen and carbon monoxide, often alongside carbon dioxide. One example of syngas may contain about 11 mol % H₂, about 22 mol % CO, about 12 mol % CO₂ along with some methane and nitrogen.

In some embodiments, the carbonylation gas is a pre-prepared mixture of H₂ and CO.

In some embodiments, the gas employed as the reducing gas is also used subsequently as the carbonylation gas. In this way, the same gas supply may be used for both the reduction and carbonylation steps, improving the efficiency of the overall process. For example, a pre-prepared mixture of H₂ and CO may be used as both the reducing gas and the carbonylation gas.

In some embodiments, the reducing atmosphere used during reduction of the waste battery material comprises a mixture of H₂ and CO, and the atmosphere during carbonylation of the reduced waste battery material also comprises a mixture of H₂ and CO. In some embodiments, the gas present during the reduction and the gas present during carbonylation are the same. In this way, there is no need to change the carrier gas between the reduction and the carbonylation and a more efficient process is provided.

When the reduction step comprises a carbothermic reduction, a product of this reduction may be CO (according to the equation NiO+C→Ni+CO). In some embodiments, the CO which is a by-product of the reduction is subsequently included in the carbonylation gas during the carbonylation reaction. This provides increased efficiency of the process.

As explained above, in some embodiments after reduction of the waste battery material the material is cooled under a nitrogen atmosphere. Therefore, in some embodiments the process comprises, after cooling under N₂, replacing the N₂ atmosphere with an atmosphere comprising the carbonylation gas and performing the carbonylation.

In some embodiments, reacting the reduced waste battery material with carbon monoxide is carried out at a temperature of at least 45° C., for example at least 46° C., at least 47° C., at least 48° C. or at least 49° C. In some embodiments, reacting the reduced waste battery material with carbon monoxide is carried out at a temperature of up to 85° C., for example up to 80° C., up to 70° C. or up to 60° C. In some embodiments, reacting the reduced waste battery material with carbon monoxide is carried out at a temperature of from 45 to 85° C., for example from 45 to 80° C., from 45 to 75° C., from 45 to 70° C., from 45 to 65° C., from 45 to 60° C., from 45 to 55° C., from 46 to 54° C., from 48 to 52° C., or a temperature of about 50° C. In such embodiments, reacting the reduced waste battery material with carbon monoxide may be carried out at a pressure of up to 200 kPa, for example up to 190 kPa, up to 180 kPa, up to 170 kPa, up to 160 kPa or up to 150 kPa. Reacting the reduced waste battery material with carbon monoxide may be carried out at a pressure of from atmospheric pressure to 200 kPa. A benefit of such temperatures and pressures is that carbonylation is performed at the same temperature to which the reduced waste battery material is cooled after reduction, so no further heating of the material is necessary after reduction. Furthermore, the lower temperature and pressure is safer and more economical.

In alternative embodiments, reacting the reduced waste battery material with carbon monoxide is carried out at a temperature of at least 140° C., for example at least 145° C., at least 150° C., at least 155° C. or at least 160° C. In some embodiments, reacting the reduced waste battery material with carbon monoxide is carried out at a temperature of up to 200° C., for example up to 190° C. or up to 180° C. In some embodiments, reacting the reduced waste battery material with carbon monoxide is carried out at a temperature of from 140 to 200° C., for example from 150 to 190° C., from 160 to 180° C., or about 170° C. In such embodiments, reacting the reduced waste battery material with carbon monoxide is carried out at a pressure of from 6 MPa to 8 MPa, for example from 6.5 MPa to 7.5 MPa, or about 7 MPa.

In some embodiments the period between the end of step (b) and the beginning of step (c) is less than 1 hour.

In some embodiments, the reduced waste battery material is kept under inert atmosphere at all times between the end of step (b) and the beginning of step (c). This ensures that the elemental nickel metal in the product of step (b) does not undergo any reaction before step (c), to preserve a high yield.

The carbonylation reaction time will depend upon the pressure used. At around atmospheric pressure, the residence time of the material in the carbonylation reactor may be around 100 hours. The residence time may be reduced at higher pressures.

As explained above, Ni(CO)₄ is volatile under the conditions of the carbonylation reaction, so the method may comprise extracting gaseous Ni(CO)₄ product from the reaction vessel.

In some embodiments the carbonylation is carried out on the reduced waste battery material in the same vessel as the reduction. In this way, there is no need to handle or move the material between the different reaction steps, providing a simple and safe method.

In some embodiments, after the reduced waste battery material has been subjected to carbonylation, one or more further reduction-carbonylation steps are carried out. This ensures that as much nickel as possible is recycled from the waste battery material. Depending on the efficiency of the reduction, some unreduced nickel may remain in the material after the first reduction and carbonylation. Thus performing one or more further reduction-carbonylation steps is a way to maximise the amount of nickel recycled and thereby the yield of the process.

Thus in some embodiments, the process comprises:
(a) providing waste battery material comprising a nickel-containing compound;
(b) reducing at least some of the nickel in the waste battery material to the zero oxidation state to provide a reduced waste battery material;
(c)(i) reacting the reduced waste battery material with carbon monoxide to form Ni(CO)₄; and
(c)(ii) repeating one or more times steps (b) and (c)(i) on the reduced carbonylated material which is a by-product of step (c)(i).

The nickel carbonyl which is a product of the method is a useful source of nickel which may be used in various applications, in particular as a source of nickel metal. For example, it is known that Ni(CO)₄ undergoes thermal decomposition into carbon monoxide and nickel in the Mond process at elevated temperature (e.g. around 300° C.). However, in preferred embodiments the Ni(CO)₄ produced in the present method is treated with a source of sulfate, such as sulfuric acid (H₂SO₄), to generate NiSO₄ as a product, as explained in more detail below. NiSO₄ is traditionally used as a precursor in the preparation of mixed transition metal oxide active materials for use in batteries. Thus, a process which generates NiSO₄ as a product from recycled battery materials is advantageous, since the NiSO₄ may then be used as a feedstock for further production of battery materials, providing a “closed loop” system.

Accordingly, the method further comprises reacting the Ni(CO)₄ with a source of sulfate to form NiSO₄. In other words, embodiments of the invention relate to a method of recycling nickel from waste battery material comprising:
(a) providing waste battery material comprising a nickel-containing compound (for example, a nickel-containing oxide);
(b) reducing at least some of the nickel in the waste battery material to the zero oxidation state to provide a reduced waste battery material;
(c) reacting the reduced waste battery material with carbon monoxide to form Ni(CO)₄; and
(d) reacting the Ni(CO)₄ with a source of sulfate to form NiSO₄.

In this way, a process in provided for preparing nickel sulfate from recycled battery materials with fewer process steps. Nickel carbonyl is converted directly into nickel sulfate which is then usable without any further process steps as a feedstock in the preparation of further battery materials. As a result, the process is simple and economical.

Any suitable source of sulfate may be used to react with the nickel carbonyl, but the source of sulfate is preferably H₂SO₄. H₂SO₄ is preferred because it reacts with nickel carbonyl to produce pure NiSO₄ along with only gaseous by-products, thereby facilitating the production of a very high purity nickel sulfate product which may be used without the need for any separate purification steps.

Without wishing to be bound by theory, it is believed that nickel carbonyl reacts with sulfuric acid to generate nickel sulfate, hydrogen and carbon monoxide in a reaction according to the following equation:

Ni(CO)₄+H₂SO₄→NiSO₄+H₂+4CO

In some embodiments, the H₂SO₄ is provided as an aqueous solution having a concentration of from 10 to 98 wt % based on the total mass of the solution, preferably from 10 to 35%.

This concentration of sulfuric acid is preferred because such highly-concentrated sulfuric acid will absorb water. Water may be generated through the oxidation of the hydrogen produced in the above reaction. However, the presence of water is undesirable because water is known to inhibit the formation of nickel carbonyl. Therefore, absorption of this water by the more concentrated sulfuric acid provides a more efficient process.

Alternatively or additionally, the process may include a step of drying the gas produced in the reaction with sulfuric acid. In some embodiments, the drying may be achieved by contacting the gas with oleum. Oleum is a solution of sulfur trioxide in sulfuric acid. Oleum reacts with water, thereby removing water from a gas which is contacted with the oleum. Such drying of the gaseous products of this reaction may be necessary for example when the gases are being recycled back into the process, since the presence of water would inhibit the formation of nickel carbonyl.

The nickel carbonyl may be contacted with the sulfuric acid by bubbling the nickel carbonyl gas through the sulfuric acid solution, or using a gas scrubber.

The reaction of Ni(CO)₄ with H₂SO₄ may be carried out in a different vessel to the above-described reduction and carbonylation steps.

In some embodiments, reacting the Ni(CO)₄ with H₂SO₄ is carried out at under the same pressure as applied during the reaction of the reduced waste battery material with carbon monoxide. In this way, alteration of the pressure during the process between steps (c) and (d) is avoided and as a result the method is more straightforward and more economical.

Reacting the Ni(CO)₄ with H₂SO₄ may be carried out at a temperature which is higher than the boiling point of Ni(CO)₄ at the reaction pressure. For example, at atmospheric pressure the boiling point of Ni(CO)₄ is 43° C., so when the reaction is carried out at atmospheric pressure the temperature may be kept above 43° C. In this way, the build-up of liquid nickel carbonyl is prevented. Preventing the build-up of nickel carbonyl provides a more efficient and safe process. If the nickel carbonyl condenses in the scrubber, it will reduce the scrubber efficiency. There is also a risk that if there is a build-up of unreacted liquid nickel carbonyl, it could all decompose at once resulting in a large release of gas, potentially causing vessel failure or explosion due to the pressure increase. Performing the reaction at a temperature above the boiling point of nickel carbonyl reduces this risk.

Optionally, the Ni(CO)₄ is reacted with H₂SO₄ to form the NiSO₄ in the presence of HNO₃ in addition to the H₂SO₄. The use of a mixture of HNO₃ and H₂SO₄ as a decomposition medium may be implemented in the event that the decomposition of Ni(CO)₄ with H₂SO₄ alone is not sufficiently effective for a particular process. A mixture of HNO₃ and H₂SO₄ is more oxidising than H₂SO₄ alone, and a heated mixture of HNO₃ and H₂SO₄ generates HNO₃ vapour which allows a homogeneous reaction between Ni(CO)₄ gas and HNO₃ gas, forming Ni(NO₃)₂ and subsequently NiSO₄ in an excess of H₂SO₄.

In some embodiments, the method further comprises recycling at least some of the H₂ which is generated as a by-product of the reaction between Ni(CO)₄ and H₂SO₄, wherein the recycled H₂ is fed back into the process. For example, the H₂ generated may be recycled into the reducing gas used to reduce the waste battery material in step (a). In this way an efficient method is provided with little or no wasted materials.

The H₂ generated as a by-product of the reaction between Ni(CO)₄ and H₂SO₄ may be dried before being fed back into the process. In some embodiments, the H₂ is dried by contacting with oleum.

In some embodiments, the method further comprises recycling at least some of the CO which is generated as a by-product of the reaction between Ni(CO)₄ and H₂SO₄, wherein the recycled CO is fed back into the process to react with the reduced waste battery material. For example, the CO generated may be recycled into the carbonylation gas used to react with the reduced waste battery material in step (b). In this way an efficient method is provided with little or no wasted materials.

The CO generated as a by-product of the reaction between Ni(CO)₄ and H₂SO₄ may be dried before being fed back into the process. In some embodiments, the CO is dried by contacting with oleum.

In some embodiments, the method further comprises recycling at least some of the mixture of H₂ and CO which is generated as a by-product of the reaction between Ni(CO)₄ and H₂SO₄, wherein the recycled H₂ and CO are fed back into the process. For example, the H₂ and CO mixture generated may be recycled into the reducing gas used to reduce the waste battery material in step (a) and/or the carbonylation gas used to react with the reduced waste battery material in step (b). In this way an efficient method is provided with little or no wasted materials.

The mixture of H₂ and CO generated as a by-product of the reaction between Ni(CO)₄ and H₂SO₄ may be dried before being fed back into the process. In some embodiments, the mixture of H₂ and CO is dried by contacting with oleum.

In some embodiments, the method comprises isolating the NiSO₄ product from the reaction mixture. This may be achieved by standard methods such as crystallisation. Alternatively, the NiSO₄ solution product may be used directly, or may be converted to a more concentrated form before use. In some embodiments, the NiSO₄ solution product is subjected to acid neutralisation to remove any residual sulfuric acid.

The process may comprise further steps to convert the NiSO₄ into other useful products. For example, the process may comprise an electrowinning step to convert the NiSO₄ into nickel metal.

In some embodiments, the method further comprises using the NiSO₄ product as a feedstock in the manufacture of a material for use in an electrical energy storage device, such as a battery material.

Another aspect of this specification is a method of recycling nickel from a waste battery material, wherein the method comprises:

reacting a composition comprising reduced waste battery material with carbon monoxide to form Ni(CO)₄, wherein the reduced battery material comprises nickel in the zero oxidation state.

Such a method which comprises a step of reacting reduced waste battery material with carbon monoxide provides a means to generate nickel carbonyl from recycled battery materials, for example recycled cathode materials. The nickel carbonyl generated is a useful product which may be utilised in downstream processes, for example for the generation of nickel or nickel sulfate. The reduced waste battery material which is fed into this method is a battery material (that is, a material which has previously been used in a component of a battery and/or generated during the production of a material to be used in a component of a battery) which has been subjected to a reduction process (for example, reacted with a reductant) such that one or more metals present within the waste battery material have undergone a change in oxidation state from an initial higher oxidation state to a subsequent lower oxidation state. In some embodiments, the reduced waste battery material is a reduced waste cathode material, that is a material which has previously been used in the cathode of a battery and/or generated during the production of a material to be used in the cathode of a battery.

Embodiments of this aspect further comprise reacting the Ni(CO)₄ with a source of sulfate (e.g. H₂SO₄) to form NiSO₄. As explained in detail above, NiSO₄ is a desirable product since it may be used directly as a precursor in the preparation of further battery materials.

The present specification also provides a method of recycling nickel from a waste battery material, wherein the method comprises:
reacting a composition comprising reduced carbonylated waste battery material with a source of sulfate to form NiSO₄, wherein the reduced carbonylated waste battery material comprises Ni(CO)₄.

Such a method which comprises a step of reacting reduced carbonylated waste battery material with a source of sulfate, such as sulfuric acid, provides a means to generate nickel sulfate from recycled battery materials, for example recycled cathode materials. The nickel sulfate generated is a useful product which may be utilised in downstream processes, for example it may be used directly as a feedstock for the preparation of further battery materials. The reduced carbonylated waste battery material which is fed into this method is a battery material (that is, a material which has previously been used in a component of a battery and/or generated during the production of a material to be used in a component of a battery) which has been subjected to a reduction process (for example, reacted with a reductant) such that one or more metals present within the waste battery material have undergone a change in oxidation state from an initial higher oxidation state to a subsequent lower oxidation state, to generate a reduced waste battery material, and a subsequent carbonylation process in which one or more metals within the reduced waste battery material are reacted with carbon monoxide. In some embodiments, the reduced carbonylated waste battery material is a reduced carbonylated waste cathode material, that is a material which has previously been used in the cathode of a battery and/or generated during the production of a material to be used in the cathode of a battery.

The present specification also provides the use of carbon monoxide as a carbonylation reagent to convert a composition comprising reduced waste battery material to Ni(CO)₄.

Another aspect of the present specification is the use of a source of sulfate, such as sulfuric acid, as a reagent to convert a composition comprising reduced carbonylated waste battery material to NiSO₄, wherein the reduced carbonylated waste battery material comprises Ni(CO)₄.

All of the options and preferences described above in respect of the first described aspect apply equally to these other aspects of the present specification.

### EXAMPLES

### Example 1

A battery cathode material containing a mixed oxide of nickel, manganese and cobalt in oxide form and copper and iron in either metallic or oxide form, and carbon as a binding material is heated to 700° C. in a reaction vessel. After the vessel has reached 700° C., a gaseous mixture of hydrogen and carbon monoxide is flowed over the cathode material.

The gas feed is stopped and the reaction vessel is fed with an inert nitrogen atmosphere. The reduced material is then cooled to around 50° C. Once the temperature reaches 50° C., the nitrogen gas feed is stopped and the supply of gaseous mixture of hydrogen and carbon monoxide is resumed.

The gas which exits the reaction vessel is then reacted with concentrated sulfuric acid in a series of gas scrubbers. This is done counter-currently.

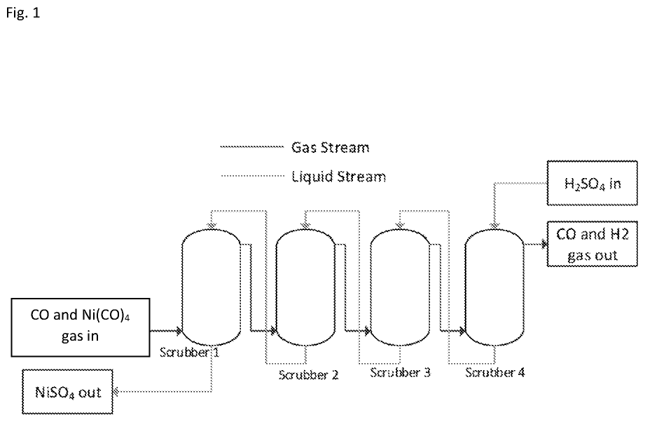

FIG. 1 shows one embodiment of a setup for reacting the Ni(CO)₄ gas with sulfuric acid. The setup includes four gas scrubbers running counter-currently. The gas which contains CO and Ni(CO)₄ is fed into “Scrubber 1”, then into “Scrubber 2” and so on. The H₂SO₄ solution is fed counter-currently to the gas, first into “Scrubber 4”, then “Scrubber 3” and so on. The sulfuric acid concentration will decrease as it moved from one scrubber to the next as more sulfuric acid is consumed to produce nickel sulfate. The nickel sulfate product is drawn off from Scrubber 1 and is the correct specification for use as a nickel precursor in a battery manufacturing process. However one or more concentration or acid neutralisation steps may be carried out before the nickel sulfate product is used in a battery manufacturing process.

The sulfuric acid is concentrated to remove any water produced in the reduction. CO and H₂ generated in the reaction can be recycled. When the reaction is complete, nickel sulfate is isolated from the reaction mixture.

1. A method of recycling nickel from waste battery material comprising:
(a) providing waste battery material comprising a nickel-containing compound;
(b) reducing at least some of the nickel in the waste battery material to the zero oxidation state to provide a reduced waste battery material;
(c) reacting the reduced waste battery material with carbon monoxide to form Ni(CO)₄; and
(d) reacting the Ni(CO)₄ with a source of sulfate to form NiSO₄.

2. (canceled)

3. The method according to claim 1, wherein the nickel-containing compound is a mixed oxide further comprising one or more of lithium, cobalt and manganese and optionally further comprising one or more of iron, aluminium, copper and carbon.

4. The method according to claim 1, wherein reducing the nickel comprises contacting the waste battery material with a reducing gas comprising H₂, wherein the contacting with the reducing gas is carried out at a temperature of at least 500° C.

5. The method according to claim 4, further comprising cooling the reduced waste battery material from the temperature of at least 500° C. to a temperature of from 45 to 85° C. after reduction and before reacting the reduced waste battery material with carbon monoxide.

6. The method according to claim 4, wherein the reducing gas further comprises carbon monoxide.

7. The method according to claim 1, wherein reacting the reduced waste battery material with carbon monoxide is carried out at a temperature of from 45 to 85° C.

8. The method according to claim 7, wherein reacting the reduced waste battery material with carbon monoxide is carried out at an absolute pressure of from 110 kPa to 200 kPa.

9. The method according to claim 1, wherein reacting the reduced waste battery material with carbon monoxide is carried out at a temperature of from 140 to 200° C.

10. The method according to claim 9, wherein reacting the reduced waste battery material with carbon monoxide is carried out at a pressure of from 6 MPa to 8 MPa.

11. (canceled)

12. The method according to claim 1, wherein the source of sulfate is H₂SO₄ such that the Ni(CO)₄ is reacted with the H₂SO₄ to form the NiSO₄.

13. The method according to claim 12, wherein the H₂SO₄ is an aqueous solution having a concentration of from 10 to 35% based on the total mass of the solution.

14. The method according to claim 12, wherein reacting the Ni(CO)₄ with H₂SO₄ is carried out at under the same pressure as applied during the reaction of the reduced waste battery material with carbon monoxide.

15. The method according to claim 12, wherein reacting the Ni(CO)₄ with H₂SO₄ is carried out under conditions of temperature and pressure in which Ni(CO)₄ is gaseous.

16. The method according to claim 12, further comprising recycling at least some of the H₂ which is generated as a by-product of the reaction between Ni(CO)₄ and H₂SO₄, wherein the recycled H₂ is fed back into the process.

17. The method according to claim 12, further comprising recycling at least some of the CO which is generated as a by-product of the reaction between Ni(CO)₄ and H₂SO₄, wherein the recycled CO is fed back into the process to react with the reduced waste battery material.

18. (canceled)

19. The method according to claim 12, wherein reacting the Ni(CO)₄ with the H₂SO₄ to form the NiSO₄ is done in the presence of HNO₃ in addition to the H₂SO₄.

20. (canceled)

21. (canceled)

22. The method according to claim 1, further comprising a formic acid leaching process before or after step (b).

23. A method of recycling nickel from a waste battery material, wherein the method comprises:
reacting a composition comprising reduced battery material with carbon monoxide to form Ni(CO)₄, wherein the reduced battery material comprises nickel in the zero oxidation state; and
reacting the Ni(CO)₄ with a source of sulfate to form NiSO₄.
